(19) United States
(12) Patent Application Publication
(10) Pub. No.: US 2025/0187956 A1
(43) Pub. Date: Jun. 12, 2025

(54) Method for cleaning a composition for conveying floating objects of a hydraulic conveyor of such objects, hydraulic conveyor and facility equipped with such a conveyor

(71) Applicant: MAF AGROBOTIC, Montauban (FR)

(72) Inventor: Philippe BLANC, MONTAUBAN (FR)

(21) Appl. No.: 18/274,168

(22) PCT Filed: Jan. 26, 2022
(86) PCT No.: PCT/FR2022/050147

§ 371 Date: Feb. 3, 2025

(30) Foreign Application Priority Data
Jan. 29, 2021 (FR) FR2100889

(51) Int. Cl. C02F 1/76; C02F 1/00; C02F 1/32; C02F 103/32

(52) U.S. Cl. CPC C02F 1/76; C02F 1/004; C02F 1/325; C02F 2103/32; C02F 2209/005; C02F 2303/04

(57) ABSTRACT

The invention relates to a method (70) for cleaning an aqueous composition, referred to as the conveying composition (61), for conveying floating objects belonging to the group of fruits and vegetables, in a hydraulic conveyor of such floating objects, the hydraulic conveyor being of a type; —with the recirculation of the conveying composition (61), and; —with treatment of the conveying composition (61) by addition of chlorine dioxide (65) kept in the conveying composition (61) during the conveying of such floating objects for the purposes of controlling the microbiological flora growing in the conveying composition (61), whereby a conveying composition, referred to as a chlorate-rich composition (66), comprising the chlorate anion of general formula (C [symbol] O₃) in a hydrated form in the chlorate-rich composition (66), is formed due to this treatment; method in which, the hydraulic conveyor being devoid of floating objects and the addition of chlorine dioxide (65) in the chlorate-rich composition (66) being suspended; a flow rate of a composition, referred to as the composition (42) to be cleaned, formed by mixing a flow of the chlorite-rich composition (66) and at least one flow of a composition, referred to as the photoreactive composition (40), comprising at least one photo-sensitive compound chosen from the group formed of sulfite anion salts, bisulfite anion salts, disulfite anion salts and salts of a hydrosulfite anion is irradiated (75) by an electromagnetic radiation comprising at least one electromagnetic wave in the UV-C range, so as to form, in this composition (42) to be cleaned, at least one compound, referred to as the active compound (77), capable of reacting chemically with chlorate anion F and forming a conveying composition, referred to as the cleaned composition (67), with a concentration of chlorate anion less than the concentration of chlorate anion in the chlorate-rich composition (66). The invention also relates to a hydraulic conveyor equipped with a cleaning device for implementing such a method.

The invention relates to a method for cleaning an aqueous composition for conveying floating objects belonging to the group of fruit and vegetables, of a hydraulic conveyor of such floating objects. The invention also relates to a hydraulic conveyor equipped with a cleaning device of such a conveying composition, a packaging facility—in particular a facility for grading and packaging—of such floating objects equipped with at least one such hydraulic conveyor.

Throughout the text:
the expression “floating objects” denotes objects displaying sufficient flotation in a stream of a liquid conveying composition to be able to be transported by this stream. This terminology covers not only objects floating on the surface of the stream of liquid composition, but also objects immersed in the liquid composition, but whose density is low enough to allow them to be transported in the stream of liquid composition, in particular immersed between two bodies of water;
the terms “upstream” and “downstream” are defined relative to the local direction of flow of the composition for conveying said floating objects in a hydraulic conveyor;
the term “cleaning” denotes in a general way the complete or partial removal of undesirable matter—of a biological nature or chemical nature—in particular of matter that may be pathogenic or toxic to humans or is subject to regulations controlling its use—of a conveying composition of a hydraulic conveyor;
the term “recirculation” regularly denotes the movement of a liquid conveying composition in a closed circuit. Describing a hydraulic conveyor, the expression “with recirculation of conveying composition” denotes a hydraulic conveyor in which a volume of conveying composition is propelled so as to circulate in the hydraulic conveyor and transport floating objects, without requiring a significant supply of conveying composition compensating a flow of conveying composition downstream of the hydraulic conveyor;
the expression “at least approximately” indicates, in the usual way, that a structural or functional feature should not be taken as marking an abrupt discontinuity, which would not have physical meaning, but covers not only this structure or this function, but also slight variations of this structure or of this function that produce, in the technical context under consideration, an effect of the same nature, if not of the same degree.

After harvesting, floating objects such as fruit and vegetables—for example, but not exclusively, apples—may be conveyed by flotation in a facility for grading and/or packaging of these fruits and/or of these vegetables in which they are graded as a function of criteria such as their size and/or their shape and/or their color and/or their weight and/or one of their qualities —internal or external—, and grouped in batches of fruits and/or vegetables having identical or similar characteristics with a view to packaging them in batches and/or marketing them.

Said fruits and/or vegetables harvested in the open air necessarily bear microorganisms—in particular undesirable microorganisms—distributed on the surface of these fruits and/or vegetables and/or in deep or superficial wounds. While they are being conveyed by a hydraulic conveyor for the purposes of grading and/or packaging, these fruits and/or vegetables are in contact with a liquid conveying composition, in which these microorganisms are disseminated and are able to grow and multiply uncontrollably. Such uncontrolled growth of microorganisms in the conveying composition is undesirable. It is undesirable, because contamination of healthy fruits and/or vegetables by microorganisms carried by damaged fruit must be limited to the maximum degree. It is undesirable, because production of toxins by microorganisms that produce such toxins must be limited to the maximum degree.

However, that is the situation in a facility for grading and/or packaging of fruits and/or of vegetables comprising a hydraulic conveyor or hydraulic conveyors of the type with recirculation of conveying composition, in which recently harvested fruit and vegetables are regularly introduced for the purposes of being graded and packaged, so that the microorganisms carried by these fruits and/or vegetables are transferred to the conveying composition with a cumulative effect. This results in an increase in the level of microorganisms—in particular of undesirable microorganisms—at least by accumulation of said microorganisms in the conveying composition as new fruits and/or vegetables are brought in, but also owing to growth of these microorganisms.

Uncontrolled accumulation of microorganisms in the conveying composition is undesirable since it may lead to contamination, with said undesirable microorganisms and/or with said toxins, of fruits and/or of vegetables that were not carriers of them at the time of harvesting. It is also unacceptable since the fruits and/or vegetables conveyed may have, after packaging, contents of undesirable microorganisms and/or of toxins that do not meet the requirements of the food standards.

The growth of undesirable microorganisms in the conveying composition can be controlled by periodically renewing the conveying water of the hydraulic conveyor. Said renewal is not environmentally acceptable, taking into account the large volume of water (several tens of cubic meters) necessary for conveying fruit and vegetables.

The invention aims to overcome all of these drawbacks.

For this purpose, the invention aims to propose a method for cleaning an aqueous conveying composition, called conveying composition, a hydraulic conveyor for implementing said method, and a facility comprising a conveyor of this kind, making it possible to extend the usage time of said conveying composition.

The invention also aims to propose a said method and a said hydraulic conveyor for implementing said method, making it possible to control the growth of microorganisms in said conveying composition of a hydraulic conveyor of the type with recirculation of conveying composition.

Thus, the invention aims to propose a said method and a said hydraulic conveyor making it possible to control the level of undesirable microorganisms present in said conveying composition, the conveying composition thus purified moreover meeting the regulatory requirements and the standards relating to foodstuffs.

The invention also aims to propose a said method and a said hydraulic conveyor making it possible to clean up said conveying composition and form a purified conveying composition that is substantially free from undesirable byproducts formed as a result of this purification.

The invention also aims to propose a said method and a said hydraulic conveyor making it possible to defer renewal of all or most of the conveying composition of a hydraulic conveyor of the type with recirculation of conveying composition.

The invention also aims to propose a said method and a said hydraulic conveyor allowing production of graded and/or packaged fruits and/or vegetables that meet the regulatory requirements relating to the amounts of undesirable matter associated with packaged fruit and vegetables intended for human consumption.

The invention also aims to propose a said hydraulic conveyor of a facility for grading and/or packaging of fruits and/or of vegetables making it possible to package fruit and vegetables that are substantially free from undesirable byproducts.

For this purpose, the invention relates to a method for cleaning an aqueous conveying composition, called conveying composition, for conveying floating objects belonging to the group of fruit and vegetables, in a hydraulic conveyor of said floating objects, the hydraulic conveyor being of a type;
with recirculation of said conveying composition, and
with treatment of said conveying composition by supplying chlorine dioxide (ClO₂) maintained in said conveying composition during the conveying of said floating objects for the purpose of controlling the microbiological flora developing in said conveying composition, whereby a conveying composition, called chlorate-rich composition, comprising the trioxochlorate anion of general formula (ClO₃⁻) in hydrated form in the aqueous conveying composition is formed as a result of this treatment;
   in said method, the hydraulic conveyor being devoid of floating objects and the addition of chlorine dioxide to said chlorate-rich composition being suspended; a flow of a composition, called composition to be cleaned up, formed by mixing a flow of said chlorate-rich composition and at least one flow of a composition, called photoreactive composition, comprising at least one photosensitive compound selected from the group comprising salts of a sulfite anion (SO₃²⁻), salts of a bisulfite anion (HSO₃⁻), salts of a disulfite anion (S₂O₅²⁻) (also called “metabisulfite anion”), salts of a hydrosulfite anion (S₂O₄²⁻) (also called “dithionite anion”) is irradiated with electromagnetic radiation comprising at least one electromagnetic wave in the UV-C region (i.e. with a wavelength between 100 nm and 280 nm), so as to form, in said composition to be cleaned up, at least one compound, called active compound, able to react chemically with the trioxochlorate anion of said composition to be cleaned up and to form a conveying composition, called purified composition, with a concentration of trioxochlorate anion below the concentration of trioxochlorate anion in said chlorate-rich composition.

The invention therefore relates to a method for cleaning the conveying composition (or conveying water) of a hydraulic conveyor of the type with treatment of said conveying composition with chlorine dioxide. The use of chlorine dioxide (ClO₂) makes it possible to control effectively the proliferation of microorganisms—in particular of viruses—in said conveying composition, including at low concentration—in particular of the order of 0.10 ppm to 0.20 ppm. Chlorine dioxide also makes it possible to control the proliferation of a biofilm that may develop at the solid/liquid interface of a hydraulic conveyor. In the context of the conveying of fruit and vegetables, to date the inventors have not identified any microorganism that has developed resistance to chlorine dioxide.

This being so, said treatment with chlorine dioxide leads to byproducts, including the trioxochlorate anion, of formula (ClO₃⁻), in hydrated form in the aqueous conveying composition, also called “chlorate anion” or “chlorate”, which constitute undesirable byproducts beyond a threshold value of concentration.

The method of cleaning according to the invention makes it possible to maintain the concentration of trioxochlorate anion in said conveying composition of a hydraulic conveyor of floating objects, of the type with disinfection treatment of said conveying composition with chlorine dioxide, at an acceptable level for conveying floating objects intended for use as food, by avoiding complete or partial replacement of said conveying composition enriched with trioxochlorate anion owing to this disinfection treatment, with a conveying composition with a lower concentration of trioxochlorate anion.

Thus, the inventors have discovered that it is possible to prolong the duration of use of said conveying composition of a hydraulic conveyor of the type with recirculation of said conveying composition, while satisfying the regulatory recommendations with respect to food grade compliance of the products and methods for treatment of water intended for human consumption, thus making recycling of this conveying composition possible. They discovered that although chlorine dioxide used continuously—i.e. throughout the conveying—as disinfectant of said conveying composition, produces trioxochlorate anion, which accumulates in said conveying composition owing to this continual usage, it is possible to maintain the concentration of trioxochlorate anion within the limit of the regulatory recommendations, by irradiation with ultraviolet light in the UV-C region, of a composition to be cleaned up formed by mixing a flow of said chlorate-rich composition, substantially free from chlorine dioxide, and a flow of said photoreactive composition.

In a method according to the invention for cleaning of said conveying composition, the treatment for microbiological control of said conveying composition is maintained by supplying chlorine dioxide (of formula ClO₂) to said conveying composition throughout the period of conveying of the floating objects by said conveying composition. This treatment for microbiological control is carried out by continuous or intermittent—periodical in particular—addition of chlorine dioxide to said conveying composition so that the proportion by weight of chlorine dioxide in said conveying composition is between 0.05 ppm and 1.5 ppm, in particular between 0.05 ppm and 0.2 ppm, in particular of the order of 0.1 ppm, the proportion by weight of chlorine dioxide being an average proportion by weight evaluated on the basis of the total volume of said conveying composition of the hydraulic conveyor in question. As a result of this treatment for microbiological control, trioxochlorate anion, called “chlorate anion” or “chlorate” (ClO₃⁻), is formed in said conveying composition.

In a method according to the invention:
the treatment for microbiological control of said conveying composition is interrupted by supplying chlorine dioxide;
the hydraulic conveyor is purged of the floating objects conveyed by said conveying composition, and then
following the treatment for microbiological control, in the absence of any introduction of chlorine dioxide into said chlorate-rich composition, the flow of said composition to be cleaned up comprising at least one photosensitive compound is formed, and said composition to be cleaned up is irradiated with electromagnetic radiation comprising at least one electromagnetic wave in the UV-C region—in particular at least one electromagnetic wave with a wavelength between 250 nm and 260 nm, so as to form, in said composition to be cleaned up, at least one active compound able to react chemically with the trioxochlorate anion of said composition to be cleaned up.

In a method according to the invention, the flow of said photoreactive composition is supplied to the flow of said chlorate-rich composition and the flow of said composition to be cleaned up, formed as a result of said supply, is irradiated with electromagnetic radiation comprising at least one electromagnetic wave in the UV-C region by circulating said composition to be cleaned up in an irradiation chamber equipped with at least one source of light in the UV-C region. A flow of a composition rich in active compound(s) able to react chemically with at least one trioxochlorate anion is thus formed. As a result of reaction, the concentration of trioxochlorate anions decreases in said composition and may thus be brought to a value below the threshold value fixed by the regulations.

According to certain embodiments, said composition to be cleaned up is irradiated with electromagnetic radiation while shielded from atmospheric air.

According to certain embodiments, said photoreactive composition is an aqueous solution of sodium bisulfite of formula HNaSO₃. Sodium bisulfite itself meets the regulatory requirements of circular DG 5/VS 4 No. 2000-166 of 28 Mar. 2000 relating to food grade compliance of products and methods for treatment of water intended for human consumption. However, there is no reason why, in other embodiments, said photoreactive composition should not comprise a plurality of photosensitive compounds different than sodium bisulfite. There is also no reason why, in other embodiments, said photoreactive composition should not comprise sodium bisulfite and at least one other photosensitive compound different than sodium bisulfite.

According to certain embodiments, an amount of sodium bisulfite is introduced into the flow of said chlorate-rich composition such that the proportion by weight of sodium bisulfite introduced into said chlorate-rich composition is between 50 ppm and 200 ppm.

The flow of said photoreactive composition is formed by pumping said photoreactive composition held in a storage tank equipped with a pump for distribution of said photoreactive composition into the flow of conveying composition at the level of a mixing site located upstream and as close as possible to the upstream inlet of a cylindrical irradiation chamber traversed longitudinally by the flow of said composition to be cleaned up.

According to certain embodiments, the electromagnetic radiation comprises at least one electromagnetic wave in the UV-C region, of wavelength between 100 nm and 280 nm, in particular approximately of the order of 254 nm. Advantageously, the irradiation wavelength and/or the intensity of the electromagnetic radiation and/or the flow of said composition to be cleaned up are adapted according to the chemical nature and the photochemical reactivity of the photosensitive compound(s). In certain embodiments, the flow of said composition to be cleaned up is irradiated by means of an irradiation device formed from at least one mercury vapor lamp emitting ultraviolet light. In certain advantageous embodiments, the irradiation device is formed from five lamps arranged parallel to one another in the interior space of a cylindrical irradiation chamber traversed longitudinally by the flow of said composition to be cleaned up. Advantageously, the lamps are arranged in the cylindrical irradiation chamber so as to occupy the five vertices of a regular pentagon and so as to able to extend in contact with said composition to be cleaned up circulating in the cylindrical irradiation chamber. The power of each lamp may be of the order of 300 W.

According to certain embodiments, the flow of said photoreactive composition and the concentration of the photosensitive compound in said photoreactive composition are adjusted so as to maintain a concentration by weight of trioxochlorate anion in said purified composition that is compatible with its use as a composition for conveying floating objects belonging to the group of fruit and vegetables, so that the floating objects conveyed meet the regulatory requirements relating to fruit and vegetables, in particular so as to maintain a concentration by weight of trioxochlorate anion in said purified composition at most equal to 10 ppm in said purified composition, in particular at most equal to 5 ppm in said purified composition, preferably at most equal to 3 ppm in said purified composition. Thus, the floating objects conveyed by the conveying composition meet the regulatory requirements relating to foodstuffs in general and to floating objects belonging to the group of fruit and vegetables.

In certain embodiments, when floating objects are being conveyed by said conveying composition, a predetermined concentration of chlorine dioxide is maintained in said conveying composition—in particular in the conveying trough(s), that is low, for example between 0.1 ppm and 0.2 ppm, but sufficient to allow control of the microbiological flora in said conveying composition and maintain its sanitary state. It is, moreover, low enough so as not to cause changes in the outward appearance of the floating objects conveyed, in particular appearance of lenticels. Said concentration of chlorine dioxide satisfies the recommendations of the regulations with respect to foodstuffs. As a guide, the maximum concentration (by weight, in mg/kg) of chlorine dioxide recommended by the regulations is:
0.2 ppm with respect to bottled water;
0.8 ppm with respect to drinking water (0.5 ppm on average), and
2.5 ppm with respect to water intended for horticulture.

In certain embodiments, during the conveying of floating objects by said conveying composition, the predetermined concentration of chlorine dioxide in said conveying composition is maintained by mixing a flow of said conveying composition, for which a controlled microbiological state is required to be maintained, and a flow of a composition—in particular an aqueous composition, for microbiological control, called disinfecting composition, comprising chlorine dioxide. In certain embodiments, said disinfecting composition is formed by mixing an aqueous solution of sodium chlorite (NaClO₂), an aqueous solution of hydrochloric acid (HCl) and water. The flow of said disinfecting composition is introduced into the flow of said conveying composition taken from a store of disinfecting composition or from said disinfecting composition prepared extemporaneously by mixing, on demand, aqueous solution of sodium chlorite (NaClO₂), aqueous solution of hydrochloric acid (HCl), and water.

In certain embodiments, the flow of said purified composition undergoes oxygenation treatment, promoting dissolution of gaseous oxygen (O₂) in the flow of said purified composition. Any means is employed for the oxygenation treatment. It may be a treatment of aeration of said purified composition with atmospheric air. In this oxygenation treatment, gaseous oxygen (O₂) is introduced into said purified composition so as to form a purified conveying composition substantially free from photosensitive compound and/or active compound. Thus, said conveying composition:
is controlled microbiologically by continuous treatment of said conveying composition with chlorine dioxide;
has a concentration of trioxochlorate anion such as to enable the conveyed floating objects themselves to meet the regulatory recommendations with respect to foodstuffs, and
has a concentration of photosensitive compound—in particular of sulfite—that is compatible on the one hand with subsequent use of said conveying composition for the purpose of conveying objects intended for human food and on the other hand with subsequent continuous treatment of said conveying composition with chlorine dioxide for the purpose of controlling its bacteriologic state during the conveying of floating objects.

Any means may be employed for carrying out the oxygenation treatment of said purified composition. For example, it may be carried out by introducing gaseous oxygen (O₂) into said purified composition. It may be carried out by introducing a precursor of gaseous oxygen (O₂) into said purified composition, the precursor being able to undergo decomposition, with release of gaseous oxygen (O₂). It may be carried out by introducing atmospheric air into said purified composition.

In certain embodiments, for the purpose of oxygenation, said purified composition is submitted to vortex flow in a tank that is intended (during the conveying of floating objects such as fruit and vegetables) for the hydraulic filling of crates or box pallets, also called “palox”, for storage and/or transport of said floating objects. This filling tank is placed at the downstream end of a collecting channel delivering a hydraulic stream into the filling tank that is able to transport floating objects and that opens out into the top of the filling device. The box pallet is held in the filling device so as to retain the floating objects conveyed by said conveying composition flowing in the collecting channel while being transparent with respect to said conveying composition, which flows by pumping at the bottom of the filling device. Said tank intended for filling box pallets is used for these purposes for packaging floating objects in batches. Said tank, intended for filling box pallets with floating objects, is used in a method according to the invention, in the absence of floating objects conveyed in the flow of said conveying composition to be cleaned up, for oxygenating said conveying composition to be cleaned up and to decrease its concentration of sulfites. According to the invention, this oxygenation step is carried out at the end of clean-up of the conveying composition, before bringing floating objects into the conveyor.

This oxygenation is maintained for a sufficient time to lower the concentration of sulfites—in particular for a time between 1 hour and 24 hours, in particular of the order of 8 hours—prior to bringing chlorine dioxide into said conveying composition and prior to bringing floating objects into the hydraulic conveyor for the purpose of their grading and packaging. At the end of the oxygenation treatment, said conveying composition is suitable for receiving and conveying floating objects and for being disinfected by addition of chlorine dioxide.

The invention also extends to a hydraulic conveyor of floating objects belonging to the group of fruit and vegetables, of a type with recirculation of a liquid composition, called conveying composition, for conveying floating objects, and comprising:
means for introducing a composition comprising chlorine dioxide into said conveying composition—in particular a flow of a composition comprising chlorine dioxide into a flow of said conveying composition—for the purpose of controlling the microbiological flora that may develop in said conveying composition, whereby a conveying composition, called chlorate-rich composition, comprising trioxochlorate anion of general formula (ClO₃⁻) in hydrated form in said chlorate-rich composition, is formed as a result of said introduction;
a device for distribution and mixing of a flow of a composition, called photoreactive composition, comprising at least one photosensitive compound in a flow of said chlorate-rich composition and formation of a flow of a composition to be cleaned up;
at least one photosensitive compound being selected from the group comprising salts of a sulfite anion (SO₃²⁻), salts of a bisulfite anion (HSO₃⁻), salts of a disulfite anion (S₂O₅²⁻) and salts of a hydrosulfite anion (S₂O₄²⁻);
at least one irradiation device arranged downstream of the distribution device and suitable for irradiating the flow of said composition to be cleaned up with electromagnetic radiation comprising at least one electromagnetic wave in the UV-C region and so as to be able to form, as a result of this irradiation, at least one compound, called active compound, able to transform, by chemical reaction, a trioxochlorate anion of said chlorate-rich composition.

According to certain embodiments, the hydraulic conveyor according to the invention comprises:
at least one conveying trough of said floating objects—in particular at least one conveying trough of said floating objects forming a plurality of channels for accumulation and grouping of said floating objects in batches;
at least one pipeline, called filtration pipeline, for recirculation of said conveying composition free from floating objects in communication with the conveying trough via an upstream inlet of conveying composition in said filtration pipeline and via a downstream outlet of conveying composition flowing in said filtration pipeline, opening into the conveying trough, and
at least one cleaning device of said conveying composition circulating in said filtration pipeline, comprising:
   at least one device for aspiration/discharge of said conveying composition in said filtration pipeline of the cleaning device;
   the means for introducing the composition comprising chlorine dioxide into said filtration pipeline;
   the device for distribution of the flow of said photoreactive composition in said filtration pipeline;
   at least one irradiation device arranged so as to be able to irradiate the flow of said composition to be cleaned up circulating in said filtration pipeline downstream of the distributing device.

According to certain embodiments, the cleaning device comprises a unit for cleaning by solid/liquid filtration of the conveying composition circulating in the cleaning device. The cleaning unit is a unit for cleaning by filtration on sand.

According to certain embodiments, the means for introducing the flow of said composition comprising chlorine dioxide into said conveying composition are arranged in the downstream part of the cleaning device. The means for introducing the flow of said composition comprising chlorine dioxide into the flow of conveying composition are arranged so as to introduce said composition comprising chlorine dioxide as close as possible to the outlet of the cleaning device and as close as possible to the conveying trough. Such an arrangement makes it possible to limit—if not prevent completely—corrosion of the elements of the cleaning device.

According to these embodiments, the means for mixing the flow of said photoreactive composition and the flow of said conveying composition are arranged so as to form the flow of said composition to be cleaned up, upstream of the irradiation device(s).

According to these embodiments, the irradiation device(s) is (are) interposed between:
the upstream means for mixing said conveying composition and said photoreactive composition, and
the means for introducing the flow of said disinfecting composition into the flow of said conveying composition.

In certain embodiments, the means for introducing the composition comprising chlorine dioxide into said filtration pipeline comprise a unit for preparation of the composition comprising chlorine dioxide by pumping/mixing:
an aqueous solution of sodium chlorite (NaClO₂);
an aqueous solution of hydrochloric acid (HCl), and
water.

In certain embodiments, the hydraulic conveyor comprises a computing device for controlling and synchronizing:
the device(s) for aspiration/discharge;
the device for distributing the flow of said photoreactive composition in said filtration pipeline;
the irradiation device, and
the means for introducing the composition comprising chlorine dioxide into said filtration pipeline.

In certain embodiments, the means for introducing the composition comprising chlorine dioxide into said filtration pipeline opens into said filtration pipeline downstream of the irradiation device. The cleaning device elements arranged on said filtration pipeline upstream of the site of introduction of the composition comprising chlorine dioxide into said filtration pipeline are protected against corrosion.

The invention also relates to a said hydraulic conveyor for carrying out a method of cleaning according to the invention.

The invention also extends to a packaging facility—in particular a facility for grading and grouping in batches—of floating objects belonging to the group of fruit and vegetables, comprising at least one hydraulic conveyor according to the invention.

In certain embodiments, the facility comprises a line, called a line for sizing, conveying, analysis and grading of objects as a function of predetermined criteria, said calibration line being provided with means for selective discharge (not shown) of the objects in different accumulation channels of the hydraulic conveyor extending orthogonally overall to the calibration line, with an upstream end portion located underneath the discharging means of the calibration line.

Said calibration line has various stations for analysis of the objects (weighing, optical analysis, others) and is adapted to allow distribution of the objects conveyed by said calibration line in the accumulation channels of the hydraulic conveyor as a function of the analysis result, each accumulation channel receiving objects substantially meeting the same criterion for analysis and grading.

The invention also relates to a method for cleaning a conveying composition of a hydraulic conveyor of the type with recirculation of conveying composition, said hydraulic conveyor comprising a cleaning device suitable for carrying out said method and a packaging facility of objects, comprising a said hydraulic conveyor, characterized by combining some or all of the features mentioned above or hereunder. Regardless of the formal presentation thereof, unless explicitly stated otherwise, the various features mentioned above or hereunder are not to be considered as closely or inextricably linked together, and the invention may relate to only one of these structural or functional features, or only some of these structural or functional features, or only a part of one of these structural or functional features, or of any group, combination or juxtaposition of some or all of these structural or functional features.

Other aims, features and advantages of the invention will become clearer on reading the following description, which refers to the appended figures given only as a nonlimiting description of certain embodiments of the invention, and in which:

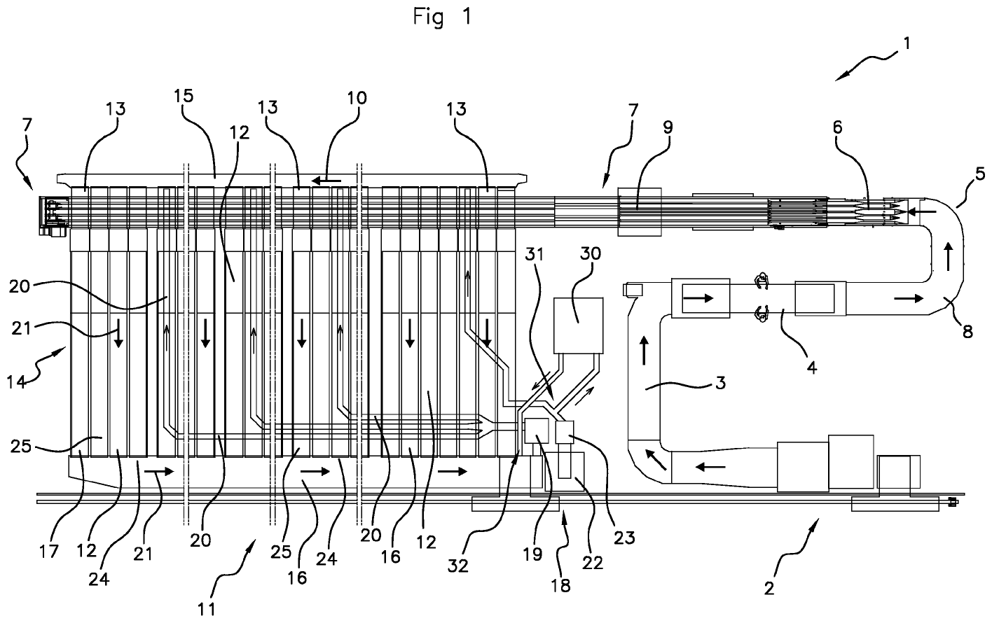

FIG. 1 is a schematic top view of an example illustrating a facility for grading and grouping of objects in batches, comprising a hydraulic conveyor according to the invention with recirculation of conveying composition and with a device for cleaning the conveying composition;

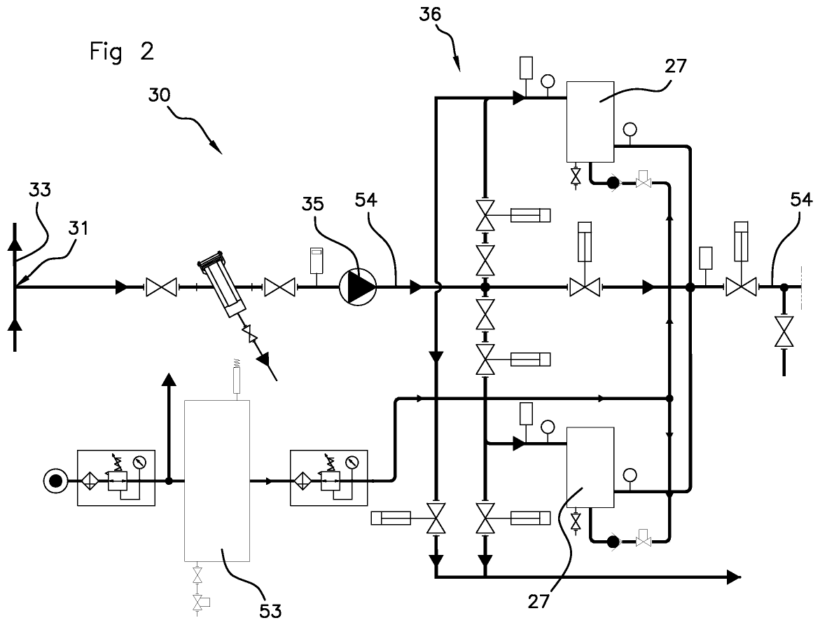

FIG. 2 is a schematic representation of an upstream part of a cleaning device of a conveying composition of a hydraulic conveyor according to the invention;

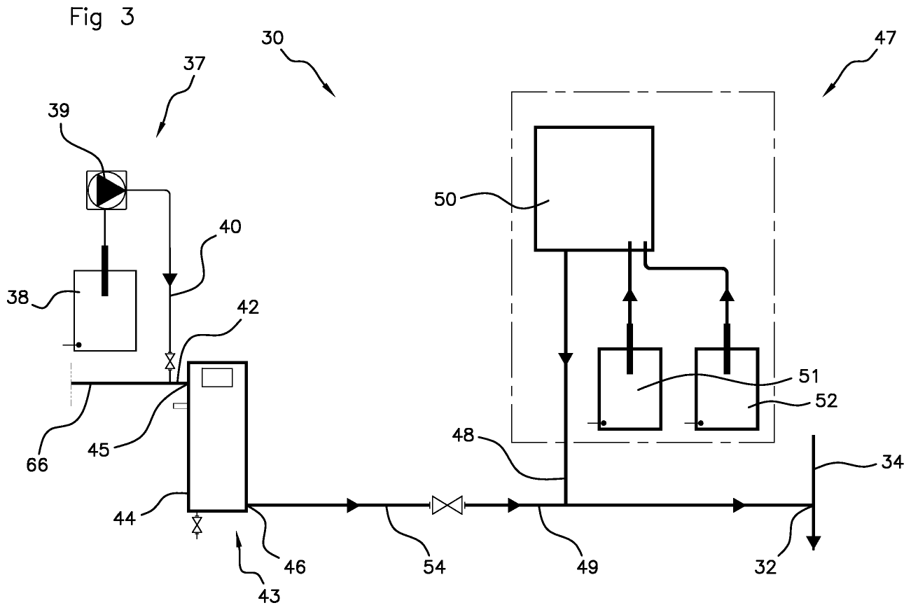

FIG. 3 is a schematic representation of a downstream part of a device for cleaning the conveying composition of a hydraulic conveyor according to the invention, complementary to the upstream part of the cleaning device shown in FIG. 2, and

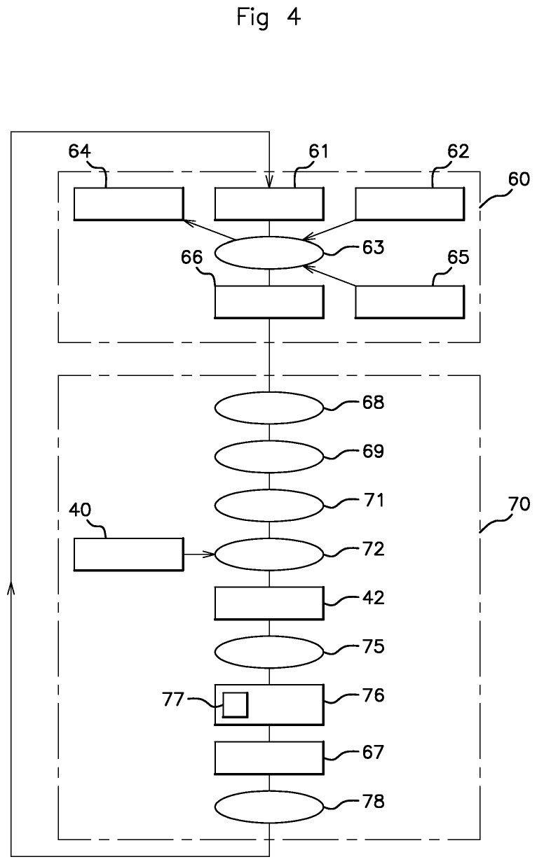

FIG. 4 is a synoptic schematic diagram illustrating a method of cleaning according to the invention for a conveying composition of a hydraulic conveyor of floating objects.

In FIGS. 1 to 3, scales and proportions are not necessarily strictly respected, purely for purposes of clarity of illustration.

FIG. 1 shows a simplified schematic diagram illustrating an example of a facility 1 for packaging of floating objects belonging to the group of fruit and vegetables, the facility 1 being of the type comprising at least one hydraulic conveyor 11 for grading and grouping of said floating objects in batches. The facility 1 for packaging of objects shown in FIG. 1 is a facility for packaging apples. Of course, a facility according to the invention for packaging floating objects belonging to the group of fruit and vegetables extends to any facility for packaging floating objects other than apples, for example pears, or of any other fruit or vegetable that floats. The facility 1 for packaging of objects shown in FIG. 1 comprises a platform 2 for unloading the apples received from the harvesting/picking site, on a first hydraulic conveyor forming a channel 3 for guiding the harvested apples to a station 4 for visual inspection of these harvested apples, the guide channel 3 containing water for conveying apples, called “first water”. The facility 1 for packaging of objects also comprises a second hydraulic conveyor 5 extending from the station 4 for visual inspection and intended to convey the apples from the station 4 for visual inspection to a longitudinal end 6 upstream of a line, called line 7 for sizing, conveying from upstream to downstream, analysis of the apples conveyed and for grading the apples as a function of criteria determined during the analysis. The second hydraulic conveyor 5 forms a channel for guiding the apples, containing conveying water and called “channel 8 of the second water”.

Said calibration line 7 is provided with means for selective discharge (not shown) of the apples conveyed by said calibration line 7, into different accumulation channels 12 of a third hydraulic conveyor 11 of a conveying composition, called “third water”, the accumulation channels 12 extending orthogonally overall to said calibration line 7. Each accumulation channel 12 comprises an upstream end portion 13 located underneath the means for selective discharge, not shown, so that each apple conveyed by said calibration line 7 is moved into the accumulation channel 12 corresponding to the analysis result for this apple. Said calibration line 7 may have one or more station(s) 9 for analysis—in particular for example a station for analysis by weighing and/or one or more station(s) for optical analysis—of the apples moved by said calibration line 7 in the direction represented by the arrow 10 shown with a dotted line.

The third hydraulic conveyor 11 is of the type with recirculation of conveying composition and is intended for conveying floating objects, in particular apples. It comprises a conveying trough 14 forming the plurality of accumulation channels 12—for example from 5 to 50 accumulation channels—parallel to one another and adjoining one another laterally and extending longitudinally between an upstream pipeline 15 for supplying the accumulation channels 12 with conveying composition, and a downstream channel 16 for collecting the apples accumulated in an accumulation channel 12 and released in the collecting channel 16. The collecting channel 16 extends orthogonally to the accumulation channels 12, along the downstream ends 17 for removing the apples from each accumulation channel 12. The third hydraulic conveyor 11 may for example contain a volume of conveying composition—in particular a volume of water—between 10 m³ and 1000 m³, in particular of the order of 30 m³ to 100 m³.

Preferably, each accumulation channel 12 is dimensioned so as to be able to receive a batch of apples intended to fill a crate or box pallet, at a receiving station 18 supplied by the collecting channel 16. Each accumulation channel 12 has a sufficient length so as to be able to receive all the apples that form one and the same batch and that have to undergo one and the same subsequent treatment. In practice, each accumulation channel 12 receives apples having specific characteristics with respect to the selection criteria, for example a predetermined size. In one and the same batch, all the apples therefore have the same characteristics or similar characteristics, in particular the same size.

The accumulation channels 12 are supplied with and traversed by a stream of aqueous conveying composition generated by a device for hydraulic recirculation of said conveying composition between the collecting channel 16 and the supply pipeline 15. The device for hydraulic recirculation is provided with recirculation pipes 20 and with means 19 for pumping a flow of said conveying composition to the downstream end of the channel 16 for collecting and discharging this flow into the supply pipeline 15 via the recirculation pipes 20. The flow of conveying composition is visualized in FIG. 1 by arrows 21 shown with a continuous line. The hydraulic stream formed in each accumulation channel 12 as a result of this recirculation is adapted so as to be able to provide transport of the floating objects—in particular of the apples—in the hydraulic stream, the upper surface of this hydraulic stream opening out into the open air.

The upstream supply pipeline 15 extends along the upstream ends 13 of each accumulation channel 12 receiving the hydraulic stream generated by the recirculation pump 19, common to the different accumulation channels 12, itself arranged so as to be able to pump, by aspiration, the aqueous conveying composition in the receiving station 18 of the stream of conveying composition conveying the apples and so as to be able to discharge, in a closed circuit, the aqueous conveying composition in the upstream supply pipeline 15 via the recirculation pipes 20. The receiving station 18 also comprises a device 22 for filling a crate and/or a box pallet, sometimes designated “palox”, with the apples circulating in the collecting channel 16. It makes it possible to package each batch of apples received from an accumulation channel 12 in one and the same package.

The filling device 22 is provided with a pump, called filler pump 23, arranged so as to be able to aspirate, at the bottom of the filling device 22, a flow of conveying composition passing through the crate positioned in the filling device 22 and allow filling of the crate retaining the apples conveyed by the stream of said conveying composition, the crate being transparent for said conveying composition. Said filler pump 23 makes it possible to discharge the flow of said conveying composition passing through the crate to the third hydraulic conveyor 11.

The hydraulic stream circulates in the accumulation channels 12, from their upstream end portion 13 extending under the discharging means of the calibration line 7, to their opposite downstream end 17 provided with a retaining/releasing device 24 making it possible, in a closed position, to retain the apples in the accumulation channel 12 while allowing the hydraulic stream to pass, and, in the open position, to release them under the effect of the hydraulic stream and transfer them into the collecting channel 16 located downstream from all the accumulation channels 12. The retaining/releasing device 24 of each accumulation channel 12 is transparent to the hydraulic stream circulating in the accumulation channel 12, including when this retaining/releasing device 24 is in the closed position for retaining the apples in a zone 25 for accumulation of the objects.

The facility 1 for packaging of objects shown in FIG. 1 is controlled by a control unit (automatic unit), generally formed from a computer system, suitable for controlling the various actuators, jacks and motors of the whole facility, in particular the calibration line 7, the discharging means, the retaining/releasing devices 24 of the accumulation channels 12, the receiving station 18, the device for hydraulic recirculation, in particular. This control unit also receives various signals from various sensors, detectors or devices for chemical analysis of said conveying composition.

The facility 1 for packaging of objects shown in FIG. 1 comprises at least one device 30 for cleaning a composition, called chlorate-rich composition, for conveying apples, enriched with trioxochlorate anion as a result of a treatment of said conveying composition with chlorine dioxide for the purpose of controlling the development of the microbiological flora in said conveying composition. The cleaning device 30 is intended to be traversable by a flow of said chlorate-rich composition for the purpose of cleaning it. The cleaning device 30 extends between an upstream inlet 31 of said chlorate-rich composition in the cleaning device 30 and a downstream outlet 32 of said purified composition leaving the cleaning device 30. The upstream inlet 31 of at least one—in particular of each—cleaning device 30 is in communication with pipework 33 conveying said chlorate-rich composition discharged by the pump 23 of the filler. The downstream outlet 32 of at least one—in particular of each—cleaning device 30 is in communication with pipework 34 for circulation of said purified composition to the filling device 22. The cleaning device 30 forms a hydraulic circuit in which said chlorate-rich composition circulates from upstream to downstream during clean-up thereof, while shielded from the atmospheric air.

A schematic diagram of a cleaning device 30 of a hydraulic conveyor according to the invention is shown in detail and in two successive complementary upstream and downstream parts in FIGS. 2 and 3. The upstream part of a cleaning device 30 shown in FIG. 2 comprises at least one pump, called filtering pump 35, making it possible to establish a flow of conveying composition free from floating objects between the upstream inlet 31 and the downstream outlet 32 of the cleaning device 30. Said filtering pump 35 is suitable for establishing said flow of conveying composition, even when the recirculating pump(s) 19 of the third hydraulic conveyor 11 and, if applicable, pump 23 of the filler is/are at a standstill. The flow of said conveying composition passes longitudinally through the cleaning device 30 that forms pipework protecting said conveying composition with respect to atmospheric air—in particular atmospheric oxygen.

The cleaning device 30 whose upstream part is shown in FIG. 2 comprises at least one device 36 for solid/liquid separation by filtration on sand 27 of the solid matter transported by the flow of said conveying composition. The device 36 for filtration on sand 27 is suitable for regeneration of the filtering sand 27 by backwash with said conveying composition and/or by backwash with compressed air 53.

The downstream part of a cleaning device 30 shown in FIG. 3 extends into the continuation of the upstream part of the cleaning device 30 shown in FIG. 2 and comprises a device 37 for distributing and mixing a flow of a composition, called photoreactive composition 40, comprising at least one photosensitive compound selected from the group comprising salts of a sulfite anion, salts of a bisulfite anion, salts of a metabisulfite anion and salts of a dithionite anion in the flow of said chlorate-rich composition 66 so as to form a flow of a composition, called composition 42 to be cleaned up, flowing in a pipeline 54 of the cleaning device 30. Said photoreactive composition 40 is stored in a reservoir 38 and the flow of said photoreactive composition 40 is formed by pumping by means of a metering pump 39 suitable for delivering a flow of said photoreactive composition 40 into the flow of said chlorate-rich composition 66.

The flow of said composition 42 to be cleaned up, formed as a result of this mixing, is propelled by the filtering pump 35 and by the metering pump 39 of said photoreactive composition 40 so as to pass through the interior space of a chamber 44 of a device 43 for irradiation of said composition 42 to be cleaned up, provided with fluorescent tubes (not shown) extending longitudinally in the irradiation chamber 44 and parallel to the longitudinal axis of this chamber 44. For example, the irradiation device 43 comprises five fluorescent tubes extending parallel to one another in the interior space of the chamber 44, each fluorescent tube being arranged so as to occupy, in the chamber 44, a vertex of a regular pentagon through any transverse cross section of the irradiation device 43. Each fluorescent tube is selected to emit electromagnetic radiation comprising at least one electromagnetic wave in the UV-C region, in particular an electromagnetic wave with a wavelength approximately of the order of 254 nm and with a power of 300 W each. The irradiation device 43 is configured to allow irradiation of said composition 42 to be cleaned up, circulating in the irradiation device 43 between an inlet 45 of the flow of said composition 42 to be cleaned up in the irradiation device 43 and an outlet 46 of a flow of conveying composition in which at least one photosensitive compound of said photoreactive composition 40 is converted into a compound, called active compound, able to react chemically with the trioxochlorate anion of said chlorate-rich composition and to form a conveying composition, called purified composition, with a concentration of trioxochlorate anion below the concentration of trioxochlorate anion in said chlorate-rich composition.

The downstream part of a cleaning device 30 shown in FIG. 3 also comprises means for introducing, into the flow 49 of said conveying composition 61, a flow of a composition comprising chlorine dioxide 65 for the purpose of controlling microbiological flora capable of developing in said conveying composition 61. The introducing means comprise a generator, called chlorine dioxide generator 47, a flow 48 of an aqueous chlorine dioxide solution (ClO₂), arranged so as to be able to introduce the flow 48 of chlorine dioxide solution in a controlled manner into the flow 49 of conveying composition and to form a conveying composition rich in chlorine dioxide flowing in the downstream part of the cleaning device 30 to the hydraulic conveyor 11. In this way, the upstream part of the cleaning device 30, in particular the irradiation chamber 44 and more generally all the components for controlling the flow of said conveying composition passing through the cleaning device 30 are protected against corrosion by chlorine dioxide.

Said chlorine dioxide generator 47 is adapted so as to be able to generate, substantially extemporaneously, an aqueous chlorine dioxide solution. It comprises a mixing/metering device 50 of a solution of sodium chlorite contained in a sodium chlorite container 51 and aqueous solution of hydrochloric acid contained in a hydrochloric acid container 52. Said chlorine dioxide generator 47 is connected to a computing device suitable for receiving data representing the concentration of chlorine dioxide at various locations of the hydraulic conveyor and for controlling said chlorine dioxide generator 47 so as to adapt the proportion/concentration of chlorine dioxide in said conveying composition.

The addition of chlorine dioxide to said conveying composition is controlled so that the proportion by weight of chlorine dioxide in said conveying composition is maintained at a nonzero value (i.e. in disinfecting proportion/concentration) and at most equal to 0.20 ppm, in particular at most equal to 0.15 ppm.

A synoptic schematic diagram of a particular embodiment of a process 70 for cleaning an aqueous composition, called conveying composition, for conveying objects from the group of fruit and vegetables in a hydraulic conveyor with recirculation of said conveying composition is shown in FIG. 4.

A method of this kind makes it possible to prolong the duration of use of said conveying composition in sanitary conditions that are maintained and in any case in sanitary conditions complying with the regulatory requirements relating to compositions intended to be in contact with foodstuffs.

A method according to the invention for cleaning a conveying composition of a hydraulic conveyor is used after a phase 60 of operation of the hydraulic conveyor belonging to facility 1 for packaging of objects of the group of fruit and vegetables. During this phase 60 of operation, a composition, called conveying composition 61, of a hydraulic conveyor is employed to allow conveying 63 of floating objects 62 belonging to the group of fruit and vegetables introduced in bulk into the facility 1 for packaging of said objects and for packaging these floating objects 62 in the form of objects 64 that have been graded and combined in batches. During conveying 63, chlorine dioxide 65 (ClO₂), as disinfectant, is added to said conveying composition 61 so as to control excessive proliferation of the microbiological flora brought by the floating objects 62 into said conveying composition 61. For this purpose, an average proportion by weight of chlorine dioxide 65 between 0.1 ppm and 0.2 ppm, in particular of the order of 0.15 ppm, is maintained in said conveying composition 61. This proportion of chlorine dioxide is sufficient to allow control of the proliferation of undesirable microorganisms and (complete or partial) disinfection of said conveying composition 61. For example, a chlorine dioxide solution 65 is prepared by mixing an aqueous solution of hydrochloric acid (HCl) at 9%, an aqueous solution of sodium chlorite (NaClO₂) at 7.5% and water, and the required flow of this chlorine dioxide solution 65 is introduced into the flow of conveying composition for which control of microbiological proliferation is desired.

In certain embodiments, during this phase 60 of operation, a flow of said conveying composition 61 is taken from the hydraulic conveyor and directed into the cleaning device 30, in which it receives a flow 48 of chlorine dioxide solution. In other embodiments, nothing prevents introduction of the flow 48 of chlorine dioxide solution into any flow of said conveying composition 61.

Owing to this complete or partial disinfection, trioxochlorate anion, of formula (ClO₃⁻) in hydrated form in the aqueous conveying composition is formed in said conveying composition 61. Furthermore, since the hydraulic conveyor is of the type with recirculation of conveying composition, said trioxochlorate anion accumulates in said conveying composition 61 owing to renewed supply of floating objects 62 in the hydraulic conveyor for the purpose of packaging thereof in batches, for example. Said trioxochlorate anion constitutes an undesirable byproduct and its proportion in said conveying composition 61 must be controlled. In particular, it is necessary to be able to establish that the proportion by weight of trioxochlorate anion in said conveying composition is below a threshold value defined by the regulations relating to foodstuffs, for example below 10 ppm (i.e. below of the order of 10 g of trioxochlorate anion per cubic meter of said chlorate-rich composition 66), in particular below 5 ppm, preferably below 3 ppm. A treatment 70 for cleaning said chlorate-rich composition 66 is carried out so as to lower the proportion of trioxochlorate anion (ClO₃⁻) in said chlorate-rich composition 66 and form a purified composition 67 suitable for reuse as conveying composition 61 in the hydraulic conveyor with recirculation of said conveying composition.

During the cleaning process 70 according to the invention, the introduction of floating objects 62 into the hydraulic conveyor is interrupted (step 68) so that as the floating objects 62 are graded, grouped in batches, packaged and removed from the hydraulic conveyor, said chlorate-rich composition 66 does not convey floating objects 62 during the cleaning treatment 70. During the cleaning process 70 according to the invention, the supply of chlorine dioxide 65 maintaining circulation of said chlorate-rich composition 66 in the hydraulic conveyor is also interrupted (step 69). During the cleaning process 70, recirculation of said chlorate-rich composition 66 is maintained (step 71) in the hydraulic conveyor, in particular recirculation at a low flow rate, i.e. at reduced flow relative to the flow of said conveying composition 61 established during the phase 60 of operation. For example, said recirculation of said chlorate-rich composition 66 is maintained with a flow between 20 m³/hour and 40 m³/hour. In particular, recirculation of said chlorate-rich composition 66 is maintained so that a flow of said chlorate-rich composition 66 passes through the cleaning device 30 by circulating in pipework, keeping said chlorate-rich composition 66 shielded from the atmospheric air. This flow is maintained by means of the filtering pump 35 of the cleaning device 30. Recirculation of said chlorate-rich composition 66 is maintained for a length of time necessary for the concentration of chlorine dioxide to decrease in said chlorate-rich composition 66. For example, this recirculation is maintained for at least 8 hours.

During the cleaning process 70, a flow of a composition, called composition 42 to be cleaned up, is formed by mixing 72 a flow of said chlorate-rich composition 66 and for at least one flow of a composition, called photoreactive composition 40, comprising at least one photosensitive compound selected from the group comprising salts of sulfite anion (SO₃²⁻), salts of bisulfite anion (HSO₃⁻) and salts of metabisulfite anion (S₂O₅²⁻). This mixing 72 is carried out as close as possible to an inlet 45 of an irradiation device 43 of said composition 42 to be cleaned up. Said composition 42 to be cleaned up, circulating in the irradiation device 43 and passing through it, is subjected, on account of this circulation, to irradiation 75 with electromagnetic radiation comprising at least one electromagnetic wave in the UV-C region, in particular an electromagnetic wave with a wavelength of the order of 254 nm. A photoactivated composition 76 comprising at least one compound, called active compound 77, able to react chemically with the trioxochlorate anion, is formed as a result of this irradiation 75. Owing to this chemical reaction, said chlorate-rich composition 66 is converted into a conveying composition, called purified composition 67, having a proportion of trioxochlorate anion that is decreased relative to the proportion of trioxochlorate anion of said chlorate-rich composition 66. Advantageously, the irradiation 75 is carried out while shielded from atmospheric air. In a cleaning process 70, during mixing 72 of said chlorate-rich composition 66 and the flow of said photoreactive composition 40, supply of chlorine dioxide 65 is interrupted. Thus, when the device 37 for distribution of a flow of said photoreactive composition 40 in the flow of said chlorate-rich composition 66 is activated and when said composition 42 to be cleaned up is formed as a result of this mixing and circulates in the cleaning device 30, and when the irradiation device 43 is activated so as to irradiate said composition 42 to be cleaned up passing through the irradiation chamber 44, the chlorine dioxide generator 47 is inactivated and no flow of chlorine dioxide is supplied to said conveying composition during cleaning.

In a method according to the invention for cleaning said chlorate-rich composition, a flow of said chlorate-rich composition is taken, the flow of said composition 42 to be cleaned up is formed and said composition 42 to be cleaned up is subjected to irradiation with ultraviolet light in the irradiation chamber 44 while being shielded from atmospheric air.

Recirculation of said chlorate-rich composition 66 is maintained in the cleaning device 30 so that substantially the whole of said chlorate-rich composition 66 contained in the hydraulic conveyor passes through the cleaning device 30. The mixing 72 of the flow of said chlorate-rich composition 66 and the flow of said photoreactive composition 40 and the irradiation 75 of said composition 42 to be cleaned up are maintained for a time between 1 hour and 72 hours, in particular for a time of the order of 10 hours to 50 hours so as to form said purified composition 67.

In certain embodiments of a cleaning process 70 according to the invention, said purified composition 67 undergoes an oxygenation step 78 for inactivating at least a proportion of the photosensitive compound(s) and/or of the residual active compound(s) of said purified composition 67 prior to its use as recycled conveying composition 61 in an operating step 60. In particular, said purified composition 67 undergoes a said oxygenation step 78 prior to addition of chlorine dioxide 65 to said recycled conveying composition 61. This oxygenation of said purified composition 67 may be carried out by activating the recirculating pump 19 for mixing said purified composition 67 in the hydraulic conveyor and/or by activating pump 23 of the filler to create an aeration vortex of said purified composition 67.

Said conveying composition 61 formed at the end of the cleaning treatment 70 and circulating in the hydraulic conveyor satisfies the regulatory requirements relating to the products and methods for treatment of water intended for human consumption and having a reduced concentration of trioxochlorate anion, below 3 ppm.

### EXAMPLE 1—CLEANING THE CONVEYING WATER IN THE TROUGH OF THE THIRD WATER OF A CHAIN FOR PRELIMINARY SIZING OF APPLES—TREATMENT OF THE TRIOXOCHLORATE ANION

A simplified flowsheet of said chain for preliminary sizing of apples is shown in FIG. 1. The chain for preliminary sizing comprises a pilot device for filtration and cleaning of the conveying water of the hydraulic conveyor of the third water. The pilot device for filtration and cleaning extends between an inlet (identified by reference 31 in FIGS. 1 and 2) of conveying water into the device 30 for filtration and cleaning. The inlet 31 is in communication of conveying water with pipework for returning conveying water by the pump 23 of the filler. The outlet (identified by reference 32 in FIGS. 1 and 3) is in communication of conveying water with pipework for delivering conveying water to the filling device 22. However, other configurations are possible.

The chain for preliminary sizing is kept in operation for 1.5 months by regular supply of apples for packaging in batches. For the whole operating time, the average concentration of chlorine dioxide (ClO₂) in the conveying water of the trough of the third water is maintained at an average value of chlorine dioxide between 0.10 ppm and 0.20 ppm, in particular of the order of 0.15 ppm. The volume of water circulating in the trough of the third water is about 60 m³. No uncontrolled development of undesirable microorganisms is detected in the conveying water. Owing to this treatment with chlorine dioxide, salts of the chlorate anion (ClO₃⁻) are formed in the conveying water. At the end of this period of operation, the measured concentration of chlorate anion is 3.90 mg/L (3.90 ppm). This concentration does not meet the regulatory requirements relating to the products and methods for treatment of water intended for human consumption. Operation of the chain for preliminary sizing is interrupted. The supply of apples, addition of chlorine dioxide to the conveying water and recirculation of the conveying water by the recirculating pump 19 are interrupted. 2 hours after stopping the supply of chlorine dioxide, circulation of the conveying water in the cleaning device 30 is activated by switching on the filtering pump 35, leading to flow of said chlorate-rich composition (conveying water) in the pipework of the cleaning device. A flow of a solution of sodium bisulfite (NaHSO₃) (CAS No. 7631-90-5) is introduced into the flow of chlorate-rich conveying water so that the flow of the mixture formed passes through the interior space of the irradiation chamber 44 of the irradiation device 43, whose fluorescent tubes emit ultraviolet light with wavelength of the order of 254 nm. The supply of the solution of sodium bisulfite and the irradiation at wavelength of the order of 254 nm are maintained for 15 hours. At the end of this period, supply of sodium bisulfite is interrupted. The average concentration of chlorate anion as measured in the conveying water is 2.60 mg/L (2.60 ppm). This concentration satisfies the regulatory requirements relating to the products and methods for treatment of water intended for human consumption. The abatement rate of trioxochlorate anion (ClO₃⁻) is 33%. The controlled supply of chlorine dioxide is restored and the chain for preliminary sizing is ready to be supplied with fruits or vegetables.

### EXAMPLE 2—CLEANING THE CONVEYING WATER OF THE TROUGH OF THE THIRD WATER OF A CHAIN FOR PRELIMINARY SIZING OF APPLES—TREATMENT OF TRIOXOCHLORATE ANION

A simplified flowsheet of said chain for preliminary sizing of apples is shown in FIG. 1. The chain for preliminary sizing is kept in operation for 2 months by regular supply of apples for packaging in batches. For the whole operating time, the average concentration of chlorine dioxide (ClO₂) in the conveying water of the trough of the third water was maintained at an average value between 0.10 ppm and 0.20 ppm, in particular of the order of 0.15 ppm. No uncontrolled development of undesirable microorganisms is detected in the conveying water. At the end of this period of operation, the measured concentration of chlorate anion in the conveying water is 3.77 mg/L (3.77 ppm). This concentration does not meet the regulatory requirements relating to the products and methods for treatment of water intended for human consumption. The operation of the chain for preliminary sizing is interrupted. The supply of apples, addition of chlorine dioxide to the conveying water and recirculation of said chlorate-rich composition (conveying water) by the recirculating pump 19 are interrupted. 24 hours after stopping the supply of chlorine dioxide, circulation of the chlorate-rich conveying water in the cleaning device 30 is activated. A flow of a solution of sodium bisulfite (NaHSO₃) is introduced into the flow of chlorate-rich conveying water so that the flow of the mixture formed passes through the interior space of the irradiation chamber 44 of the irradiation device 43, whose fluorescent tubes irradiate the chlorate-rich conveying water with ultraviolet light with wavelength of the order of 254 nm. Supply of the solution of sodium bisulfite and irradiation are maintained for 36 hours. At the end of this period, supply of sodium bisulfite is interrupted. The average concentration of trioxochlorate anion as measured in the conveying water is 2.76 mg/L (2.76 ppm). This concentration means that floating objects conveyed by said conveying water meet the regulatory requirements relating to products intended for human consumption. The abatement rate of trioxochlorate anion (ClO₃⁻) is 27%. Controlled supply of chlorine dioxide is restored and the chain for preliminary sizing is ready to be supplied with floating objects belonging to the group of fruit and vegetables.

The cleaning treatment according to the invention combining supply of a photosensitive compound selected from the group comprising salts of a sulfite anion (SO₃²⁻), salts of a bisulfite anion (HSO₃⁻) and salts of a disulfite anion (S₂O₅²⁻)—also designated “metabisulfite anion”—, salts of a hydrosulfite anion (S₂O₄²⁻)—also designated “dithionite anion”—, in the composition or the conveying water rich in trioxochlorate anion and treatment by irradiation of the composition formed as a result of this supply, makes it possible to maintain the concentration of trioxochlorate anion at a value compatible with the regulatory requirements, without requiring partial or complete replacement of the conveying composition. The cleaning treatment according to the invention allows recycling of the composition for a longer time, giving a saving of water.

The invention is amenable to numerous variants and applications other than those described above. In particular, it goes without saying that unless stated otherwise, the various structural and functional features of each of the embodiments described are not to be regarded as combined and/or closely and/or inextricably linked to one another, but on the contrary as mere juxtapositions. Furthermore, the structural and/or functional features of the various embodiments described above may undergo, wholly or partly, any different juxtaposition or any different combination.

1. A method for cleaning a composition, called aqueous conveying composition, for conveying floating objects belonging to the group of fruit and vegetables, in a hydraulic conveyor of such floating objects, the method comprising:
recirculation of said conveying composition, and
treatment of said conveying composition by supply of chlorine dioxide maintained in said conveying composition during the conveying of said floating objects for the purpose of controlling the microbiological flora developing in said conveying composition, whereby a conveying composition, called chlorate-rich composition, comprising trioxochlorate anion of general formula (ClO₃⁻) in hydrated form in the aqueous conveying composition, is formed as a result of this treatment;
wherein
the hydraulic conveyor being devoid of floating objects and addition of chlorine dioxide to said chlorate-rich composition being suspended;
a flow of a composition, called composition to be cleaned up, formed by mixing a flow of said chlorate-rich composition and at least one flow of a composition, called photoreactive composition, having at least one photosensitive compound selected from the group comprising salts of a sulfite anion, salts of a bisulfite anion, salts of a disulfite anion and salts of a hydrosulfite anion is irradiated with electromagnetic radiation comprising at least one electromagnetic wave in the UV-C region, so as to form, in said composition to be cleaned up, at least one compound, called active compound, able to react chemically with the trioxochlorate anion and form a conveying composition, called purified composition, with a concentration of trioxochlorate anion below the concentration of trioxochlorate anion in said chlorate-rich composition.

2. The method as claimed in claim 1, wherein said composition to be cleaned up is irradiated with electromagnetic radiation while shielded from atmospheric air.

3. The method as claimed in claim 1, wherein said photoreactive composition is an aqueous solution of sodium bisulfite.

4. The method as claimed in claim 3, wherein the proportion by weight of sodium bisulfite in said composition to be cleaned up is between 50 ppm and 200 ppm.

5. The method as claimed in claim 1, wherein the electromagnetic radiation comprises an electromagnetic wave with a wavelength approximately of the order of 254 nm.

6. The method as claimed in claim 1, wherein the flow of said photoreactive composition and the concentration of the photosensitive compound in said photoreactive composition are adjusted so as to maintain a concentration by weight of trioxochlorate anion in said purified composition that is below 10 ppm.

7. The method as claimed in claim 1, wherein the flow of said purified composition is submitted to an oxygenation treatment.

8. A hydraulic conveyor of floating objects belonging to the group of fruit and vegetables, of the type with recirculation of a composition, called liquid conveying composition, for conveying the floating objects, and comprising:
means for introducing a composition comprising chlorine dioxide into said conveying composition for the purpose of controlling the microbiological flora that may develop in said conveying composition, whereby a conveying composition, called chlorate-rich composition, comprising trioxochlorate anion of general formula (ClO₃⁻) in hydrated form in said chlorate-rich composition, is formed as a result of said introduction;
a device for distributing a flow of a composition, called photoreactive composition, comprising at least one photosensitive compound, in a flow of said chlorate-rich composition and for forming a flow of a composition to be cleaned up;
at least one photosensitive compound being selected from the group comprising salts of a sulfite anion, salts of a bisulfite anion, salts of a disulfite anion and salts of a hydrosulfite anion;
at least one irradiation device arranged downstream of the distributing device and adapted so as to be able to irradiate the flow of said composition to be cleaned up with electromagnetic radiation comprising at least one electromagnetic wave in the UV-C region and so as to be able to form, as a result of this irradiation, at least one compound, called active compound, able to transform, by chemical reaction, the trioxochlorate anion of said chlorate-rich composition.

9. The conveyor as claimed in claim 8, wherein said conveyor further comprises:
at least one trough for conveying said floating objects;
at least one pipeline, called filtration pipeline, for recirculation of said conveying composition free from floating objects in communication with the conveying trough via an upstream inlet of conveying composition in said filtration pipeline and via a downstream outlet of conveying composition flowing in said filtration pipeline, opening into the conveying trough, and
at least one device for cleaning of said conveying composition circulating in said filtration pipeline, comprising:
at least one device for aspiration/discharge of said conveying composition in said filtration pipeline of the cleaning device;
the means for introducing the composition comprising chlorine dioxide into said filtration pipeline;
the device for distributing the flow of said photoreactive composition in said filtration pipeline;
at least one irradiation device arranged so as to be able to irradiate the flow of said composition to be cleaned up circulating in said filtration pipeline downstream of the distributing device.

10. The conveyor as claimed in claim 8, wherein said conveyor comprises a computing device for controlling and synchronizing:
the device(s) for aspiration/discharge;
the device for distributing the flow of said photoreactive composition in said filtration pipeline;
the irradiation device, and
the means for introducing the composition comprising chlorine dioxide into said filtration pipeline.

11. The conveyor as claimed in claim 8, wherein the means for introducing the composition comprising chlorine dioxide into said filtration pipeline comprise a unit for preparing the composition comprising chlorine dioxide by pumping/mixing
an aqueous solution of sodium chlorite (NaClO₂);
an aqueous solution of hydrochloric acid (HCl), and
water.

12. The conveyor as claimed in claim 8, wherein the means for introducing the composition comprising chlorine dioxide in said filtration pipeline open into said filtration pipeline downstream of the irradiation device.

13. A facility for packaging floating objects belonging to the group of fruit and vegetables, comprising at least one hydraulic conveyor as claimed in claim 8.
